(19) United States
(12) Patent Application Publication
(10) Pub. No.: US 2008/0283582 A1
(43) Pub. Date: Nov. 20, 2008

(54) Secret Postcard and Method of Fabricating the Same

(75) Inventors: Hideaki Oki, Kanagawa (JP); Kazuhiro Oki, Kanagawa (JP); Tetsushi Okumoto, Hiroshima (JP); Misako Satou, Tokyo (JP); Seisyu Yano, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: KAZUHIRO OKI, YOKOHAMA-SHI KANAGAWA (JP)

(21) Appl. No.: 11/631,038

(22) PCT Filed: Mar. 11, 2005
(86) PCT No.: PCT/JP05/04312

§ 371 Date: Dec. 28, 2006

(30) Foreign Application Priority Data
Jul. 2, 2004 (JP) 2004-196285

(51) Int. Cl. B42D 15/00; B05C 1/00

(52) U.S. Cl. 229/92.8; 493/331

(57) ABSTRACT

A secret postcard in accordance with the present invention is comprised of a single sheet, and a released paper. The sheet is foldable about a return line, and has a first area and a second area. A first perforation, and a second perforation are formed at a front surface of the second area. A first adhesive layer is formed at a rear surface of the second area in an area sandwiched between the return line and the first perforation. A second adhesive layer is formed at the rear surface of the second area in an area sandwiched between the second perforation and an edge of the second area extending in parallel with the return line. The second adhesive layer has such an adhesive force that the rear surfaces of the first and second areas cannot be released from each other after they were adhered to each other.

### BACKGROUND OF THE INVENTION

1. Field of the Invention

The invention relates to a postcard which is capable of preventing what is written therein from being seen by others during delivery thereof (called “a secret postcard”), and a method of fabricating the same.

2. Background Art

A lot of secret postcards have been suggested so far in order to prevent what is written in a postcard from being seen by persons other than a recipient.

For instance, there have been suggested a postcard which is foldable about a folded line as a center line, and includes an adhesive layer formed on one of inner surfaces thereof for allowing one of inner surfaces to be released from and re-adhered to the other, and a postcard including a seal for hiding what is written therein (for instance, see Japanese Patent Application Publications Nos. 7-17166 and 11-129654).

In accordance with the former, it is possible to hide what is written in a postcard by adhering two inner surfaces to each other through the adhesive layer. In accordance with the latter, it is possible to hide what is written in a postcard by adhering the seal to the postcard.

3. Disclosure Of The Invention

Problem to be Solved by the invention

However, since the adhesive layer and the seal in the above-mentioned conventional secret postcards can be adhered again, if a third party other than a recipient opens the postcard, and, after reading what is written in the postcard, adhere two inner surfaces of the postcard to each other or adhere the seal again to the postcard, the postcard would return to an unopened condition. Accordingly, it is not possible to become aware that a third party other than a legitimate recipient had read what is written in the postcard.

In view of the above-mentioned problem in the conventional secret postcards, it is an object of the present invention to provide a secret postcard which cannot be returned to an unopened condition after it has been once open.

### Solution to the Problem

In order to achieve the above-mentioned object, there is provided, in the first aspect, a secret postcard including a single sheet, and a released paper, wherein the sheet is foldable about a return line, and has a first area and a second area, the return line being a boundary line between the first and second areas, a first perforation extending in parallel with the return line, and a second perforation spaced away from the first perforation in a direction remote from the return line, and extending in parallel with the first perforation are formed in the second area, a first adhesive layer is formed at a rear surface of the second area in an area sandwiched between the return line and the first perforation, a second adhesive layer is formed at the rear surface of the second area in an area sandwiched between the second perforation and an edge of the second area extending in parallel with the return line, the released paper is adhered onto the rear surface of the second area, the first adhesive layer has such an adhesive force that the rear surface of the second area and a rear surface of the first area can be released from each other even after they were adhered to each other, and the rear surfaces of the first and second areas can be adhered again to each other, and the second adhesive layer has such an adhesive force that the rear surfaces of the first and second areas cannot be released from each other after they were adhered to each other.

In the secret postcard in accordance with the present invention, after released paper is peeled off, the first and second areas are folded to each other about the return line to thereby adhere rear surfaces of the first and second areas to each other thorough the first and second adhesive layers. The secret postcard is delivered in such a condition. On receipt of the secret postcard, a recipient can open the secret postcard by cutting away an area sandwiched between the first and second perforations along the first and second perforations. The secret postcard in accordance with the present invention cannot be opened, unless the area sandwiched between the first and second perforations is cut away. Accordingly, if the area is not cut away when a recipient receives the secret postcard, the recipient can know that the secret postcard is not yet opened, and further, if the area were cut away, the recipient can estimate that the secret postcard was already opened, and a third party other than the recipient read what is written in the secret postcard.

The return line may be comprised merely of a line written on the postcard, or a folded line. By forming a folded line as the return line, it would be readily possible to fold the first area onto the second area.

As an alternative, the return line may be comprised of a perforation. By forming a perforation as the return line, it is possible to adhere the second area having a rear surface on which the first adhesive layer is formed, onto a wall as an information sheet, by cutting away the first and second areas after the postcard was opened, if a pattern is printed onto a front surface of the second area.

It is not always necessary to form the return line as a center line of the sheet. However, by forming the return line as a center line of the sheet, it would be possible to entirely fold the first area onto the second area.

The first adhesive layer may be formed at the rear surface of the second area in an almost entire area.

It is not always necessary to form the first adhesive layer at the rear surface of the second area in an almost entire area. The first adhesive layer may be formed so as to enable a rear surface of the second area to be adhered to a rear surface of the first area in such an area that what is written in a rear surface of the first area is hidden when a rear surface of the second area is adhered to a rear surface of the first area

It is preferable that an area sandwiched between the first and second perforations has different color or pattern from other areas.

A recipient can readily find an area to be cut away by using the different color or pattern from other areas' color or pattern as an eye mark in place of the first and second perforations.

There is further provided, in the second aspect, a secret postcard including a single sheet, and a released paper, wherein the sheet is foldable about a return line, and has a first area and a second area, the return line being a boundary line between the first and second areas, a first perforation extending in parallel with the return line, and a second perforation spaced away from the first perforation in a direction remote from the return line, and extending in parallel with the first perforation are formed in the second area, a first non-adhesive layer is formed at a rear surface of the first area, a second adhesive layer is formed at a rear surface of the second area, the first non-adhesive layer is formed so as not to overlap an area sandwiched between the second perforation and an edge of the second area extending in parallel with the return line when the rear surface of the first area is aligned with the rear surface of the second area about the return line, the released paper is adhered onto the rear surface of the second area, the first non-adhesive layer can be released from the second adhesive layer even after the rear surfaces of the first and second areas were adhered to each other, and the second adhesive layer has such an adhesive force that the rear surfaces of the first and second areas cannot be released from each other after they were adhered to each other.

In the secret postcard in accordance with the present invention, after the released paper is peeled off, the first and second areas are folded to each other about the return line to thereby adhere rear surfaces of the first and second areas to each other thorough the first adhesive layer. Then, the third area is folded about the second return line to thereby adhere a rear surface of the third area onto a front surface of the first area through the second adhesive layer. The secret postcard is delivered in such a condition. On receipt of the secret postcard, a recipient can open the secret postcard by cutting away an area sandwiched between the first and second perforations along the first and second perforations. The secret postcard in accordance with the present invention cannot be opened, unless the area sandwiched between the first and second perforations is cut away. Accordingly, if the area is not cut away when a recipient receives the secret postcard, the recipient can know that the secret postcard is not yet opened, and further, if the area were cut away, the recipient can estimate that the secret postcard was already opened, and a third party other than the recipient read what is written in the secret postcard.

There is further provided, in the third aspect, a secret postcard including a single sheet, and a released paper, wherein the sheet is foldable about each of a first return line and a second return line, and defines a first area and a second area at opposite sides of the first return line, and a third area and the second area at opposite sides of the second return line, a first perforation extending in parallel with the second return line, and a second perforation spaced away from the first perforation in a direction remote from the second return line, and extending in parallel with the first perforation are formed in the third area, a first adhesive layer is formed at a rear surface of the second area, a second adhesive layer is formed at a rear surface of the third area in an area sandwiched between the second perforation and an edge of the third area extending in parallel with the second perforation, the released paper is adhered onto the rear surfaces of the second and third areas, the first adhesive layer has such an adhesive force that the rear surfaces of the first and second areas can be released from each other even after they were adhered to each other, and the rear surfaces of the first and second areas can be adhered again to each other, and the second adhesive layer has such an adhesive force that the rear surface of the third area and a front surface of the first area cannot be released from each other after they were adhered to each other.

In the secret postcard in accordance with the present invention, after released paper is peeled off, the first and second areas are folded to each other about the return line to thereby adhere rear surfaces of the first and second areas to each other thorough the first and second adhesive layers. Since the first non-adhesive layer is releasable from the second adhesive layer, a rear surface of the first area is not substantially adhered to a rear surface of the second area in an area of a rear surface of the first area in which the first non-adhesive layer is formed. A rear surface of the first area is substantially adhered to a rear surface of the second area only in an area (an area of the first area corresponding to an area sandwiched between the second perforation and an edge of the second area extending in parallel with the return line, when the rear surfaces of the first and second areas are folded onto each other about the return line) in which the first non-adhesive layer is not formed. The secret postcard is delivered in such a condition. On receipt of the secret postcard, a recipient can open the secret postcard by cutting away an area sandwiched between the first and second perforations along the first and second perforations. This is because, since the first non-adhesive layer is releasable from the second adhesive layer, the rear surfaces of the first and second areas are not adhered to each other in an area in which the first non-adhesive layer is not formed. The secret postcard in accordance with the present invention cannot be opened, unless the area sandwiched between the first and second perforations is cut away. Accordingly, if the area is not cut away when a recipient receives the secret postcard, the recipient can know that the secret postcard is not yet opened, and further, if the area were cut away, the recipient can estimate that the secret postcard was already opened, and a third party other than the recipient read what is written in the secret postcard.

There is further provided a method of fabricating a secret postcard in accordance with the first aspect, including cutting a postcard out of a paper, simultaneously forming the first and second adhesive layers at the rear surface of the second area, adhering the released paper to the rear surface of the second area, and simultaneously forming the first and second perforations in the second area.

It is possible to fabricate the secret postcard in accordance with the first aspect by carrying out the above-mentioned method.

It is preferable that the method further includes printing a pattern onto at least one of the first and second areas.

It is preferable that the method further includes forming one of a folded line and a perforation as the return line.

There is further provided a method of fabricating a secret postcard in accordance with the second aspect, including cutting a postcard out of a paper, forming the first non-adhesive layer at the rear surface of the first area, forming the second adhesive layer at the rear surface of the second area, adhering the released paper to the rear surface of the second area, and simultaneously forming the first and second perforations in the second area.

It is possible to fabricate the secret postcard in accordance with the second aspect by carrying out the above-mentioned method.

It is preferable that the method further includes printing a pattern onto at least one of the first, second and third areas.

It is preferable that the method further includes forming one of a folded line and a perforation as the first and second return lines.

There is further provided a method of fabricating a secret postcard in accordance with the third aspect, including cutting a postcard out of a paper, simultaneously forming the first adhesive layer at the rear surface of the second area and the second adhesive layer at the rear surface of the third area, adhering the released paper to the rear surface of the second area, and simultaneously forming the first and second perforations in the third area.

It is possible to fabricate the secret postcard in accordance with the third aspect by carrying out the above-mentioned method.

### Advantages Provided by the Invention

In the secret postcard in accordance with the present invention, it is not possible to open the secret postcard in accordance with the present invention, unless an area sandwiched between the first and second perforations is cut away. Accordingly, if the area is not cut away when a recipient receives the secret postcard, the recipient can know that the secret postcard is not yet opened, and further, if the area were cut away, the recipient can estimate that the secret postcard was already opened, and a third party other than the recipient read what is written in the secret postcard.

### BEST EMBODIMENT FOR PUTTING THE INVENTION INTO PRACTICE

### First Embodiment

FIG. 1 is a plan view of a front surface of the secret postcard in accordance with the first embodiment of the present invention, FIG. 2 is a plan view of a rear surface (a released paper is not adhered thereonto) of the secret postcard in accordance with the first embodiment of the present invention, FIG. 3 is a plan view of a rear surface (a released paper is adhered thereonto) of the secret postcard in accordance with the first embodiment of the present invention, and FIG. 4 is a cross-sectional view taken along the line A-A in FIG. 3.

Hereinbelow is explained a secret postcard 10 in accordance with the first embodiment of the present invention, with reference to FIGS. 1 to 4.

The secret postcard 10 in accordance with the first embodiment of the present invention is comprised of a single sheet 11 made of paper, and a released paper 19.

The sheet 11 is formed with a return line 12 along a center line, and the sheet 11 is foldable about the return line 12.

The sheet 11 has a first area 13 and a second area 14. The return line 12 is a boundary line between the first and second areas 13 and 14. The first area 13 is equal in size to the second area 14. The first area 13 has a front surface 13a (see FIG. 1) and a rear surface 13b (see FIG. 2), and the second area 14 has a front surface 14a (see FIG. 1) and a rear surface 14b (see FIG. 2). Each of the first and second areas 13 and 14 is equal in size to a currently available postcard.

A frame 20a in which a stamp is to be adhered and a frame 20b in which a postal code is to be written are printed in advance on the front surface 13a of the first area 13.

In the second area 14 are formed a first perforation 15 extending in parallel with the return line 12, and a second perforation 16 spaced away from the first perforation 15 in a direction remote from the return line 12, and extending in parallel with the first perforation 15. As illustrated in FIG. 1, the first and second perforations 15 and 16 are formed in the vicinity of an edge 14c of the second area 14 disposed opposite to the return line 12.

As illustrated in FIGS. 2 and 4, a first adhesive layer 17 (obliquely hatched area) is formed on the rear surface 14b of the second area 14 in an area sandwiched between the return line 12 and the first perforation 15 except an area existing in the vicinity of the return line 12. A second adhesive layer 18 (obliquely hatched area) is formed on the rear surface 14b of the second area 14 in an area sandwiched between an edge 14c of the second area 14 and the second perforation 16.

As illustrated in FIGS. 3 and 4, the released paper 19 is attached onto the rear surface 14b of the second area 14, that is, onto both the first adhesive layer 17 and the second adhesive layer 18.

The first adhesive layer 17 has such an adhesive force that the rear surface 14b of the second area 14 and the rear surface 13b of the first area 13 can be released from each other even after they were adhered to each other, and the rear surfaces 13b and 14b of the first and second areas 13 and 14 can be adhered again to each other.

The second adhesive layer 18 has such an adhesive force that the rear surfaces 13b and 14b of the first and second areas 13 and 14 cannot be released from each other after they were adhered to each other.

Hereinbelow is explained how to use the secret postcard 10 in accordance with the first embodiment of the present invention.

First, an address and a name of a recipient are written at the front surface 13a of the first area 13, and sentences are written on the rear surface 13b of the first area 13. Then, the released paper 19 is released from the rear surface 14b of the second area 14.

Then, the first area 13 is folded in a direction K (see FIG. 4) about the return line 12 to thereby align the rear surface 13b of the first area 13 and the rear surface 14b of the second area 14 to each other. Thus, the rear surface 13b of the first area 13 and the rear surface 14b of the second area 14 are adhered to each other through the first and second adhesive layers 17 and 18.

A recipient receives the secret postcard 10 being put in the above-mentioned condition.

A recipient clamps an end of an area 21 sandwiched between the first and second perforations 15 and 16 with his/her fingers, and cut away the area 21 out of the surrounding second area 14 along the first and second perforations 15 and 16. Since the surrounding second area 14 is adhered to the first area 13 through the first and second adhesive layers 17 and 18, only the area 21 is cut away along the first and second perforations 15 and 16.

Since the area sandwiched between the second perforation 16 and the edge 14c of the second area 14 is adhered to the first area 13 through the second adhesive layer 18, the area is not peeled off the first area 13.

In contrast, since the area sandwiched between the return line 12 and the first perforation 15 is adhered to the first area 13 through the first adhesive layer 17, the area can be separated from the first area 13. After cutting away the area 21, a recipient can read what is written on the rear surface 13b of the first area 13 by separating the second area 14 existing between the return line 12 and the first perforation 15 from the first area 13 in a direction to the return line 12 from the area 21.

After a recipient has read the sentences written in the secret postcard, he/she may adhere again the second area 14 existing between the return line 12 and the first perforation 15 onto the rear surface 13b of the first area 13.

As explained above, in the secret postcard 10 in accordance with the first embodiment, a recipient can open the secret postcard 10 by cutting away the area 21 sandwiched between the first and second perforations 15 and 16. The secret postcard 10 cannot be opened, unless the area 21 is cut away. Accordingly, if the area 21 is not cut away when a recipient receives the secret postcard 10, the recipient can know that the secret postcard 10 is not yet opened, and further, if the area 21 were cut away, the recipient can estimate that the secret postcard 10 was already opened, and a third party other than the recipient read what is written in the secret postcard 10.

A structure of the secret postcard 10 in accordance with the first embodiment is not to be limited to the above-mentioned structure. Alternatives, modifications and equivalents may be applied to the secret postcard 10 in accordance with the first embodiment, as follows.

The sheet 11 is designed to have the return line 12 as a center line, but may be designed to have a perforation similar to the first and second perforations 15 and 16, in place of the return line 12.

After the secret postcard 10 was opened, the second area 14 is no longer used (because the sentences are written on the rear surface 13b of the first area 13). However, if a perforation is formed at a center line of the sheet 11, it would be possible to separate the first area 13 and the second area 14 from each other, ensuring that only the first area 13 can be reserved.

As an alternative, a line may be formed as an eye-mark at a center line of the sheet 11. The sheet 11 is folded along the line.

When an advertisement is printed on the front surface 14a of the first area 14, since the first adhesive layer 17 is formed on the rear surface 14b of the second area 14, it would be possible to adhere the separated second area 14 onto a wall to see, for instance.

Though the return line 12 is formed at a center line of the sheet 11 in the first embodiment, it is not always necessary to do so. For instance, the first area 13 may be formed bigger in size than the second area 14, and the return line 12 may be shifted towards the second area 14 from a center line of the sheet 11.

The first adhesive layer 17 in the first embodiment is formed in an almost entire area of the second area 14 except an area existing in the vicinity of the return line 12. It is not always necessary to do so.

The first adhesive layer 17 may be formed only in such an area that when the rear surface 14b of the second area 14 is adhered onto the rear surface 13b of the first area 13, the sentences written on the rear surface 13b of the first area 13 are hidden.

The area 21 sandwiched between the first and second perforations 15 and 16 may be designed to have different color and/or pattern from the surrounding second area 14 in order to readily distinguish the area 21 from the surrounding second area 14. A recipient can readily find the area 21 to be cut away by means of the area 21 having different color and/or pattern from the surrounding second area 14, acting as an eye-mark, in place of the first and second perforations 15 and 16.

In the specification, a perforation is meant to include so-called “double-bladed cut”.

FIGS. 5 and 6 illustrate an apparatus for fabricating the secret postcard 10 in accordance with the first embodiment, and FIG. 7 is a flow-chart showing a method of fabricating the secret postcard 10 in accordance with the first embodiment.

The method of fabricating the secret postcard 10 in accordance with the first embodiment is explained hereinbelow with reference to FIGS. 5, 6 and 7.

An apparatus illustrated in FIG. 5 is an offset printer.

A paper for printing is fed to a paper-cutting section 23 from a roll 22, and is cut into a size of the sheet 11 (step S01 in FIG. 7).

Then, the paper is fed to a printing section 24, in which the frames 20a and 20b are printed onto the front surface 13a of the first area 13 (step S02 in FIG. 7). When the area 21 sandwiched between the first and second perforations 15 and 16 in the front surface 14a of the second area 14 is designed to have different color from other areas, the color is printed in the area 21 in the printing section 24.

Then, the paper is once stacked.

An apparatus illustrated in FIG. 6 is a tackiness printer.

The paper is fed to an adhesive-coating section 25, in which an adhesive which will make the first adhesive layer 17 and an adhesive which will make the second adhesive layer 18 are coated onto the rear surface 14b of the second area 14 (step S03 in FIG. 7).

Then, the paper is fed into a released-paper applying section 26, in which the released paper 19 is attached onto the rear surface 14b of the second area 14, that is, onto the first and second adhesive layers 17 and 18 (step S04 in FIG. 7).

Then, the paper is fed to a perforation-forming section 27, in which the first and second perforations 15 and 16 are formed between the first and second adhesive layers 17 and 18 (step S05 in FIG. 7). When a perforation is to be formed at a center line of the sheet 11, a perforation is formed at a center line of the sheet 11 in the perforation-forming section 27 together with the first and second perforations 15 and 16.

Then, a folded line is formed at a center line of the sheet 11 in a folded-line forming section 28 (step S06 in FIG. 7).

The printing step (step S02 in FIG. 7) to be carried out in the printing section 24 may be omitted, if necessary.

### Second Embodiment

FIG. 8 is a plan view of a front surface of the secret postcard in accordance with the second embodiment of the present invention, FIG. 9 is a plan view of a rear surface (a released paper is not adhered thereonto) of the secret postcard in accordance with the second embodiment of the present invention, FIG. 10 is a cross-sectional view taken along the line B-B in FIG. 9 (a released paper is adhered thereonto), FIG. 11 is a plan view of the secret postcard in accordance with the second embodiment of the present invention in a form when mailed, and FIG. 12 is a cross-sectional view taken along the line C-C in FIG. 11.

Hereinbelow is explained a secret postcard 30 in accordance with the second embodiment of the present invention, with reference to FIGS. 8 to 12.

The secret postcard 30 in accordance with the second embodiment of the present invention is comprised of a single sheet 31 made of paper, and a released paper 41.

The sheet 31 is formed with a first return line 32a and a second return line 32b, and the sheet 31 is foldable about each of the first return line 32a and the second return line 32b.

The sheet 31 has a first area 33, a second area 34, and a third area 35. The first return line 32a is a boundary line between the first and second areas 33 and 34, and the second return line 32b is a boundary line between the second and third areas 34 and 35. The first area 33 is equal in size to the second area 34, and is equal in size to a currently available postcard. The first area 33 has a front surface 33a (see FIG. 8) and a rear surface 33b (see FIG. 9), the second area 34 has a front surface 34a (see FIG. 8) and a rear surface 34b (see FIG. 9), and the third area 35 has a front surface 35a (see FIG. 8) and a rear surface 35b (see FIG. 9).

A frame 20a in which a stamp is to be adhered and a frame 20b in which a postal code is to be written are printed in advance on the front surface 33a of the first area 33.

In the third area 35 are formed a first perforation 36 extending in parallel with the second return line 32b, and a second perforation 37 spaced away from the first perforation 36 in a direction remote from the second return line 32b, and extending in parallel with the first perforation 36. As illustrated in FIG. 8, the first and second perforations 36 and 37 are formed in the vicinity of an edge 35c of the third area 35 disposed opposite to the second return line 32b.

As illustrated in FIGS. 9 and 10, a first adhesive layer 38 (obliquely hatched area) is formed on the rear surface 34b of the second area 34 in an area sandwiched between the first and second return lines 32a and 32b except an area existing in the vicinity of the first return line 32a.

A second adhesive layer 39 (obliquely hatched area) is formed on the rear surface 14b of the second area 14 in an area sandwiched between the edge 35c of the third area 35 and the second perforation 37.

As illustrated in FIG. 10, the released paper 41 is attached onto both the rear surface 34b of the second area 34 and the rear surface 35b of the third area 35, that is, onto both the first adhesive layer 38 and the second adhesive layer 39.

The first adhesive layer 38 has an adhesive force equal to the adhesive force of the first adhesive layer 17 in the first embodiment, and the second adhesive layer 39 has an adhesive force equal to the adhesive force of the second adhesive layer 18 in the first embodiment.

Hereinbelow is explained how to use the secret postcard 30 in accordance with the second embodiment of the present invention.

First, an address and a name of a recipient are written at the front surface 33a of the first area 33, and sentences are written on the rear surface 33b of the first area 33. Then, the released paper 41 is released from both the rear surface 34b of the second area 34 and the rear surface 35b of the third area 35.

Then, the first area 33 is folded about the first return line 32a to thereby align the rear surface 33b of the first area 33 and the rear surface 34b of the second area 34 to each other. Thus, the rear surface 33b of the first area 33 and the rear surface 34b of the second area 34 are adhered to each other through the first adhesive layer 38.

Then, the third area 35 is folded about the second return line 32b to thereby align the rear surface 35b of the third area 35 onto the front surface 33a of the first area 33.

Then, as illustrated in FIGS. 11 and 12, the rear surface 35b of the third area 35 is adhered to the front surface 33a of the first area 33 through the second adhesive layer 39.

A recipient receives the secret postcard 30 being in a condition in which the first area 33, the second area 34 and the third area 35 are adhered to one another.

A recipient clamps an end of an area 40 sandwiched between the first and second perforations 36 and 37 with his/her fingers, and cut away the area 40 out of the surrounding third area 35 along the first and second perforations 36 and 37. Since the surrounding third area 35 is adhered to the front surface 33a of the first area 33 through the second adhesive layer 39, only the area 40 is cut away along the first and second perforations 36 and 37.

Since the area sandwiched between the second perforation 37 and the edge 35c of the third area 35 is adhered to the front surface 33a of the first area 33 through the second adhesive layer 39, the area is not peeled off the first area 33.

In contrast, since the second area 34 is adhered to the rear surface 33b of the first area 33 through the first adhesive layer 38, the area can be separated from the first area 33. After cutting away the area 40, a recipient can read what is written on the rear surface 33b of the first area 33 by separating the second area 34 from the first area 33.

After a recipient has read the sentences written in the secret postcard, he/she may adhere again the second area 34 onto the rear surface 33b of the first area 33.

As explained above, in the secret postcard 30 in accordance with the second embodiment, a recipient can open the secret postcard 30 by cutting away the area 40 sandwiched between the first and second perforations 36 and 37. The secret postcard 30 cannot be opened, unless the area 40 is cut away. Accordingly, if the area 40 is not cut away when a recipient receives the secret postcard 30, the recipient can know that the secret postcard 30 is not yet opened, and further, if the area 40 were cut away, the recipient can estimate that the secret postcard 30 was already opened, and a third party other than the recipient read what is written in the secret postcard 30.

Furthermore, since the first and second perforations 36 and 37 are not formed in the second area 34 in the secret postcard 30 unlike the secret postcard 10 in accordance with the first embodiment, it is possible to form the first adhesive layer 38 broader than the first adhesive layer 17 in the first embodiment. That is, it is possible to design the rear surface 33b of the first area 33 covered by the rear surface 34b of the second area 34 in which the first adhesive layer 38 is formed, to be broader than the same in the first embodiment.

A structure of the secret postcard 30 in accordance with the second embodiment is not to be limited to the above-mentioned structure. Alternatives, modifications and equivalents may be applied to the secret postcard 30 similarly to the secret postcard 10 in accordance with the first embodiment.

FIG. 13 is a flow-chart showing a method of fabricating the secret postcard 30 in accordance with the second embodiment.

The method of fabricating the secret postcard 30 in accordance with the second embodiment is explained hereinbelow with reference to FIGS. 5, 6 and 13.

Similarly to the fabrication of the secret postcard 10 in accordance with the first embodiment, the offset printer illustrated in FIG. 5 and the tackiness printer illustrated in FIG. 6 are employed for fabricating the secret postcard 30 in accordance with the second embodiment.

A paper for printing is fed to a paper-cutting section 23 from a roll 22, and is cut into a size of the sheet 31 (step S11 in FIG. 13).

Then, the paper is fed to a printing section 24, in which the frames 20a and 20b are printed onto the front surface 33a of the first area 33 (step S12 in FIG. 13). When the area 40 sandwiched between the first and second perforations 36 and 37 in the front surface 35a of the third area 35 is designed to have different color from other areas, the color is printed in the area 40 in the printing section 24.

Then, the paper is once stacked.

Then, the paper is fed to an adhesive-coating section 25, in which an adhesive which will make the first adhesive layer 38 and an adhesive which will make the second adhesive layer 39 are coated onto on the rear surface 34b of the second area 34 and the rear surface 35b of the third area 35, respectively (step S13 in FIG. 13).

Then, the paper is fed into a released-paper applying section 26, in which the released paper 41 is attached onto both the rear surface 34b of the second area 34 and the rear surface 35b of the third area 35, that is, onto the first and second adhesive layers 38 and 39 (step S14 in FIG. 13).

Then, the paper is fed to a perforation-forming section 27, in which the first and second perforations 38 and 39 are formed in the third area 35 (step S15 in FIG. 13). When a perforation is to be formed at a center line of the sheet 31, a perforation is formed at a center line of the sheet 31 in the perforation-forming section 27 together with the first and second perforations 38 and 39.

Then, a folded line is formed at a center line of the sheet 31 in a folded-line forming section 28 (step S16 in FIG. 13).

The printing step (step S12 in FIG. 13) to be carried out in the printing section 24 may be omitted, if necessary.

### Third Embodiment

FIG. 14 is a plan view of a front surface of the secret postcard in accordance with the third embodiment of the present invention, FIG. 15 is a plan view of a rear surface (a released paper is not adhered thereonto) of the secret postcard in accordance with the third embodiment of the present invention, and FIG. 16 is a cross-sectional view taken along the line D-D in FIG. 15 (a released paper is adhered thereonto).

Hereinbelow is explained a secret postcard 50 in accordance with the third embodiment of the present invention, with reference to FIGS. 14 to 16.

The secret postcard 50 in accordance with the third embodiment of the present invention is comprised of a single sheet 51 made of paper, and a released paper 59.

The sheet 51 is formed with a return line 52 along a center line, and the sheet 51 is foldable about the return line 52.

The sheet 51 has a first area 53 and a second area 54. The return line 52 is a boundary line between the first and second areas 53 and 54. The first area 53 is equal in size to the second area 54. The first area 53 has a front surface 53a (see FIG. 14) and a rear surface 53b (see FIG. 15), and the second area 54 has a front surface 54a (see FIG. 14) and a rear surface 54b (see FIG. 15). Each of the first and second areas 53 and 54 is equal in size to a currently available postcard.

A frame 20a in which a stamp is to be adhered and a frame 20b in which a postal code is to be written are printed in advance on the front surface 53a of the first area 53.

In the second area 54 are formed a first perforation 55 extending in parallel with the return line 52, and a second perforation 56 spaced away from the first perforation 55 in a direction remote from the return line 52, and extending in parallel with the first perforation 55. As illustrated in FIG. 14, the first and second perforations 55 and 56 are formed in the vicinity of an edge 54c of the second area 54 disposed opposite to the return line 52. Specifically, the second perforation 56 is spaced away from the edge 54c of the second area 54 by a distance X.

As illustrated in FIGS. 15 and 16, a first non-adhesive layer 57 (obliquely hatched area) is formed on the rear surface 53b of the first area 53. Specifically, the first non-adhesive layer 57 is formed in an area except an area disposed in the vicinity of the return line 52, and further except an area extending by a distance X from an edge 53c of the first area 53 disposed opposite to the return line 52.

A second adhesive layer 58 (obliquely hatched area) is formed on the rear surface 54b of the second area 54 in an area except an area existing in the vicinity of the return line 52.

As illustrated in FIG. 16, the released paper 59 is attached onto the rear surface 54b of the second area 54, that is, onto the second adhesive layer 58.

The second adhesive layer 58 has an adhesive force equal to the adhesive force of the second adhesive layer 18 in the first embodiment.

The first non-adhesive layer 57 may be formed by coating solvent such as varnish and silicone onto the first area 53 and drying the solvent. Accordingly, the first non-adhesive layer 57 has a polished surface, and hence, has a quite small adhesive force at a surface thereof. Accordingly, even after the rear surface 54b of the second area 54 and the rear surface 53b of the first area 53 are adhered to each other through the second adhesive layer 58, the first non-adhesive layer 57 can be separated from or peeled off the second adhesive layer 58. That is, the rear surface 54b of the second area 54 and the rear surface 53b of the first area 53 can be separated from each other in an area in which the first non-adhesive layer 57 is formed.

Hereinbelow is explained how to use the secret postcard 50 in accordance with the third embodiment of the present invention.

First, an address and a name of a recipient are written at the front surface 53a of the first area 53. It is assumed that sentences have been already written or printed on the rear surface 53b of the first area 53, and the first non-adhesive layer 57 is formed on the rear surface 53b of the first area 53. As an alternative, sentences may be written on the first non-adhesive layer 57.

Then, the released paper 59 is released from the rear surface 54b of the second area 54.

Then, the first area 53 is folded about the return line 52 to thereby align the rear surface 53b of the first area 53 and the rear surface 54b of the second area 54 to each other.

As mentioned earlier, the second area 54 can be separated from or peeled off the first area 53 in an area in which the first non-adhesive layer 57 is formed. In contrast, since the first non-adhesive layer 57 is not formed in an area extending from the edge 53c of the third area 53 by a distance X, the rear surface 53b of the first area 53 and the rear surface 54b of the second area 54 are adhered to each other through the second adhesive layer 58 only in the area.

A recipient receives the secret postcard 50 being put in the above-mentioned condition.

A recipient clamps an end of an area 61 sandwiched between the first and second perforations 55 and 56 with his/her fingers, and cut away the area 61 out of the surrounding second area 54 along the first and second perforations 55 and 56. Whereas the first non-adhesive layer 57 is formed on the first area 53 in alignment with the area 61, the second area 54 is adhered to the first area 53 through the second adhesive layer 58 in the area extending from the edge 54c of the second area 54 by a distance X. Hence, only the area 61 is cut away along the first and second perforations 55 and 56.

Since the area sandwiched between the second perforation 56 and the edge 54c of the second area 54, that is, the area extending from the edge 54c of the second area 54 by a distance X is adhered to the first area 53 through the second adhesive layer 58, the area is not peeled off the first area 53.

In contrast, though the second adhesive layer 58 is formed in the area sandwiched between the return line 12 and the first perforation 55, the first non-adhesive layer 57 is formed on the rear surface 53b of the first area 53 in association with the area in which the second adhesive layer 58 is formed. Hence, it is possible to peel the second area 54 off the first area 53. After cutting away the area 61, a recipient can read what is written on the rear surface 53b of the first area 53 by separating the second area 54 existing between the return line 52 and the first perforation 55 from the first area 53 in a direction to the return line 52 from the area 61.

After a recipient has read the sentences written in the secret postcard, he/she may adhere again the second area 54 existing between the return line 52 and the first perforation 55 onto the rear surface 53b of the first area 53.

As explained above, in the secret postcard 50 in accordance with the third embodiment, a recipient can open the secret postcard 50 by cutting away the area 61 sandwiched between the first and second perforations 55 and 56. The secret postcard 50 cannot be opened, unless the area 61 is cut away. Accordingly, if the area 61 is not cut away when a recipient receives the secret postcard 50, the recipient can know that the secret postcard 50 is not yet opened, and further, if the area 61 were cut away, the recipient can estimate that the secret postcard 50 was already opened, and a third party other than the recipient read what is written in the secret postcard 50.

A structure of the secret postcard 50 in accordance with the third embodiment is not to be limited to the above-mentioned structure. Alternatives, modifications and equivalents may be applied to the secret postcard 50, similarly to the postcard 10 in accordance with the first embodiment.

In the third embodiment, the first non-adhesive layer 57 is formed almost entirely in the first area 53 except an area existing in the vicinity of the return line 52 and an area extending from the edge 53c of the first area 53 by a distance X. It is not always necessary to so form the first non-adhesive layer 57.

The first non-adhesive layer 57 may be formed only in such an area that when the rear surface 54b of the second area 54 is adhered onto the rear surface 53b of the first area 53, the sentences written on the rear surface 53b of the first area 53 are hidden, in which case, the second adhesive layer 58 is formed only in an area corresponding to the area in which the first non-adhesive layer 57 is formed.

An example of the above-mentioned arrangement is illustrated in FIG. 17.

As illustrated in FIG. 17, the first non-adhesive layer 57 is formed in the form of a frame only along an outer edge of the first area 53 in the first area 53. The second adhesive layer 58 is formed also in the form of a frame on the rear surface 54b of the second area 54 similarly to the frame-shaped first non-adhesive layer 57. In the example illustrated in FIG. 17, sentences are written in an area surrounded by the frame-shaped first non-adhesive layer 57.

FIG. 18 is a flow-chart showing a method of fabricating the secret postcard 50 in accordance with the third embodiment.

The method of fabricating the secret postcard 50 in accordance with the third embodiment is explained hereinbelow with reference to FIG. 18.

Similarly to the fabrication of the secret postcard 10 in accordance with the first embodiment, the offset printer illustrated in FIG. 5 and the tackiness printer illustrated in FIG. 6 are employed for fabricating the secret postcard 50 in accordance with the third embodiment.

A paper for printing is fed to a paper-cutting section 23 from a roll 22, and is cut into a size of the sheet 51 (step S21 in FIG. 18).

Then, the paper is fed to a printing section 24, in which the frames 20a and 20b are printed onto the front surface 53a of the first area 53, and further, sentences are printed on the rear surface 53b of the first area 53 (step S22 in FIG. 18). When the area 61 sandwiched between the first and second perforations 55 and 56 in the front surface 54a of the second area 54 is designed to have different color from other areas, the color is printed in the area 61 in the printing section 24.

Then, the first non-adhesive layer 57 is formed on the rear surface 53b of the first area 53 in a solvent-coating section (not illustrated) by coating solvent such as varnish and silicone onto the rear surface 53b of the first area 53, and drying the solvent (step S23 in FIG. 18).

Then, the paper is once stacked.

The paper is fed to an adhesive-coating section 25, in which an adhesive which will make the second adhesive layer 58 is coated onto the rear surface 54b of the second area 54 (step S24 in FIG. 18).

Then, the paper is fed into a released-paper applying section 26, in which the released paper 59 is attached onto the rear surface 54b of the second area 54, that is, onto the second adhesive layer 58 (step S25 in FIG. 18).

Then, the paper is fed to a perforation-forming section 27, in which the first and second perforations 55 and 56 are formed in the second area 54 (step S26 in FIG. 18). When a perforation is to be formed at a center line of the sheet 51, a perforation is formed at a center line of the sheet 51 in the perforation-forming section 27 together with the first and second perforations 55 and 56.

Then, a folded line is formed at a center line of the sheet 51 in a folded-line forming section 28 (step S27 in FIG. 18).

The printing step (step S22 in FIG. 18) to be carried out in the printing section 24 may be omitted, if necessary.

### BRIEF DESCRIPTION OF THE DRAWINGS

FIG. 1 is a plan view of a front surface of the secret postcard in accordance with the first embodiment of the present invention.

FIG. 2 is a plan view of a rear surface (a released paper is not adhered thereonto) of the secret postcard in accordance with the first embodiment of the present invention.

FIG. 3 is a plan view of a rear surface (a released paper is adhered thereonto) of the secret postcard in accordance with the first embodiment of the present invention.

FIG. 4 is a cross-sectional view taken along the line A-A in FIG. 3.

FIG. 5 illustrates an apparatus for fabricating the secret postcard in accordance with the first embodiment.

FIG. 6 illustrates an apparatus for fabricating the secret postcard in accordance with the first embodiment.

FIG. 7 is a flow-chart showing a method of fabricating the secret postcard in accordance with the first embodiment.

FIG. 8 is a plan view of a front surface of the secret postcard in accordance with the second embodiment of the present invention.

FIG. 9 is a plan view of a rear surface (a released paper is not adhered thereonto) of the secret postcard in accordance with the second embodiment of the present invention.

FIG. 10 is a cross-sectional view taken along the line B-B in FIG. 9 (a released paper is adhered thereonto).

FIG. 11 is a plan view of the secret postcard in accordance with the second embodiment of the present invention in a form when mailed.

FIG. 12 is a cross-sectional view taken along the line C-C in FIG. 11.

FIG. 13 is a flow-chart showing a method of fabricating the secret postcard in accordance with the second embodiment.

FIG. 14 is a plan view of a front surface of the secret postcard in accordance with the third embodiment of the present invention.

FIG. 15 is a plan view of a rear surface (a released paper is not adhered thereonto) of the secret postcard in accordance with the third embodiment of the present invention.

FIG. 16 is a cross-sectional view taken along the line D-D in FIG. 15 (a released paper is adhered thereonto).

FIG. 17 is a plan view of a rear surface (a released paper is not adhered thereonto) of a variant of the secret postcard in accordance with the third embodiment of the present invention.

FIG. 18 is a flow-chart showing a method of fabricating the secret postcard in accordance with the third embodiment.

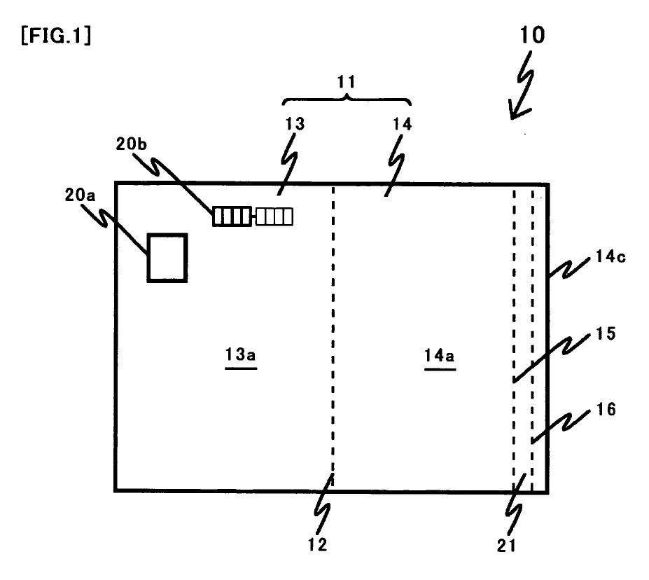

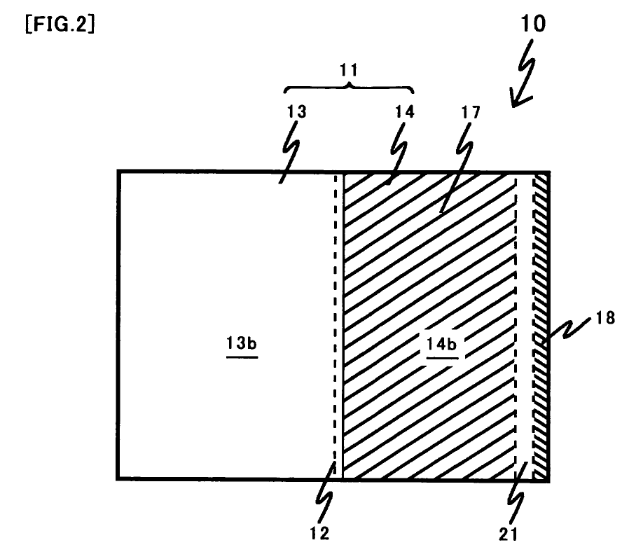

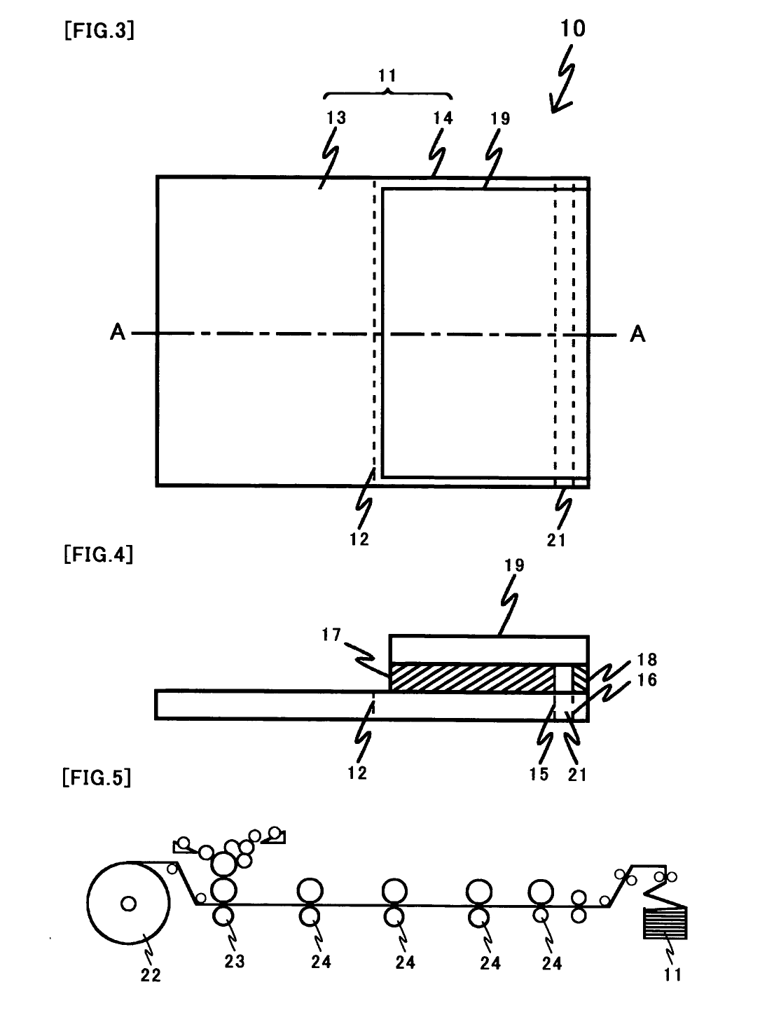

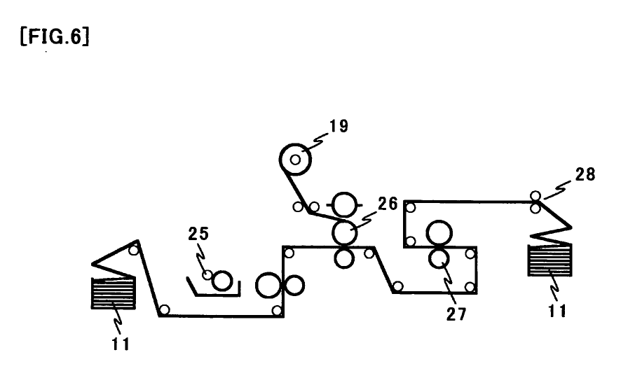

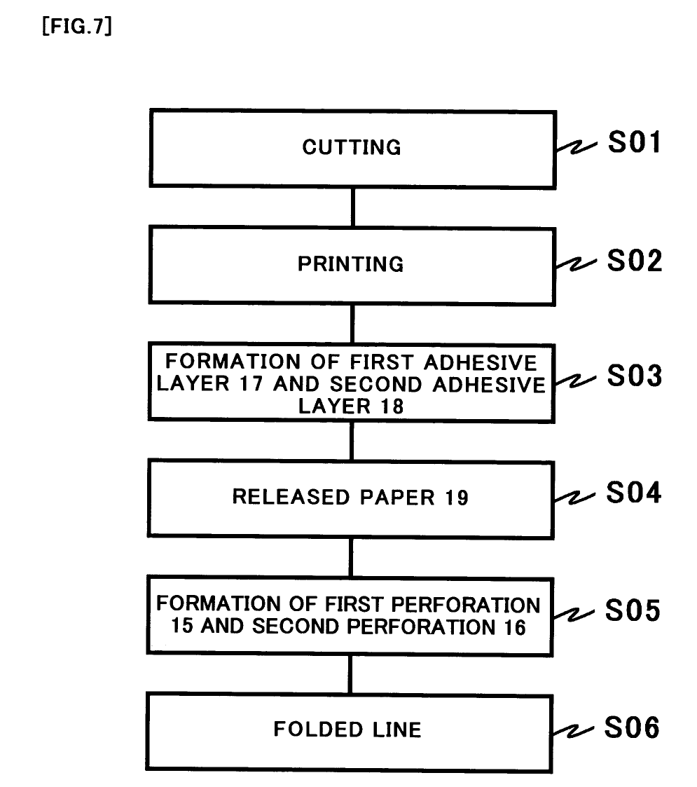

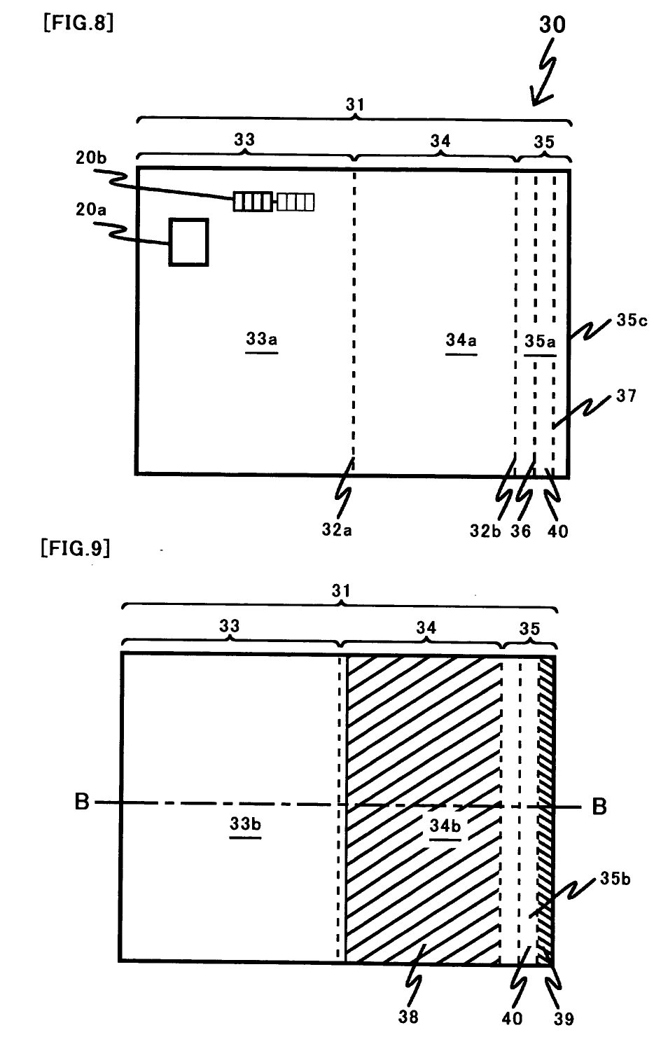

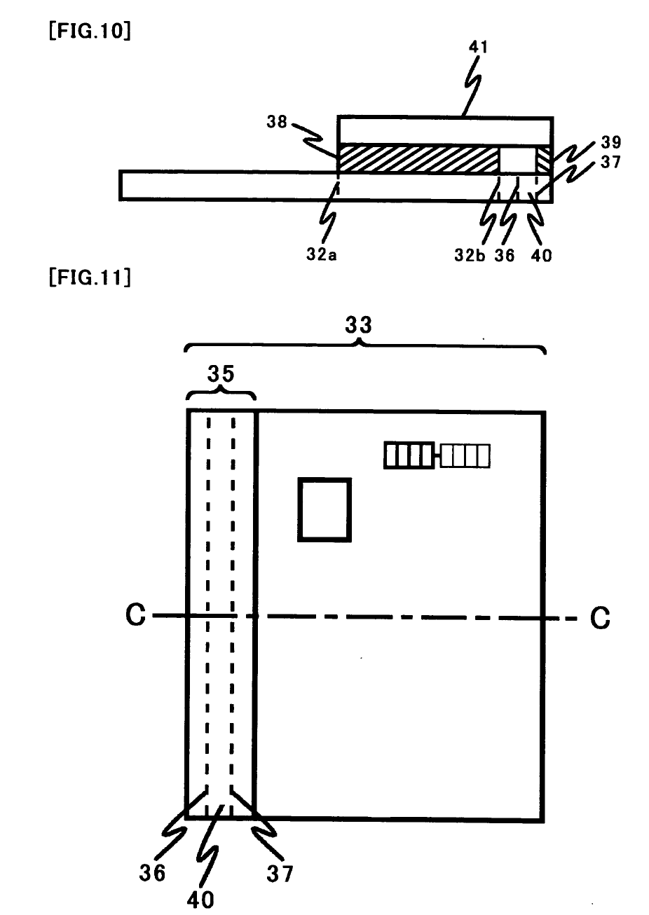

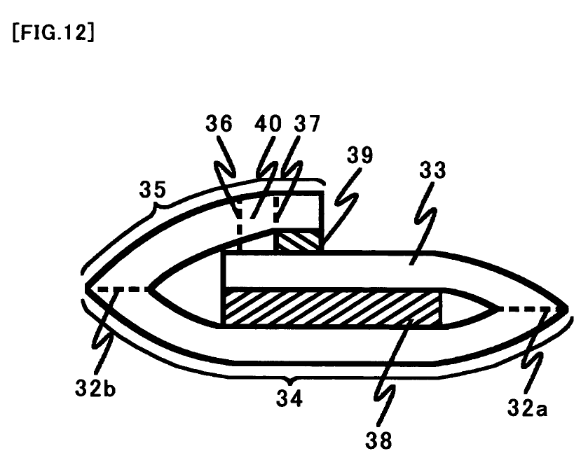

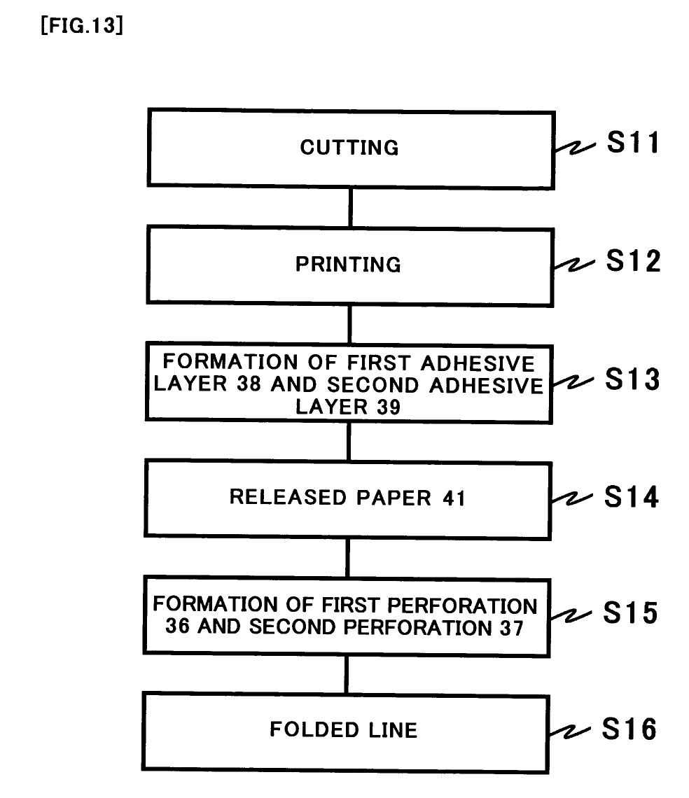

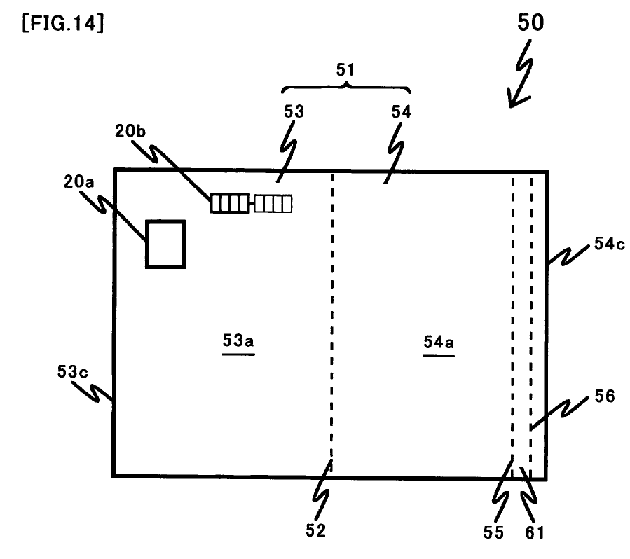

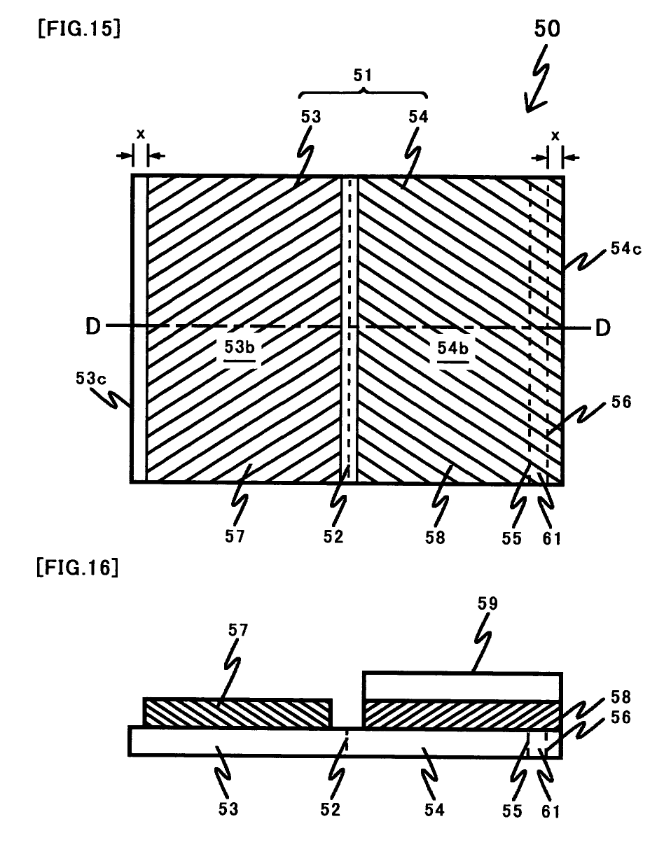

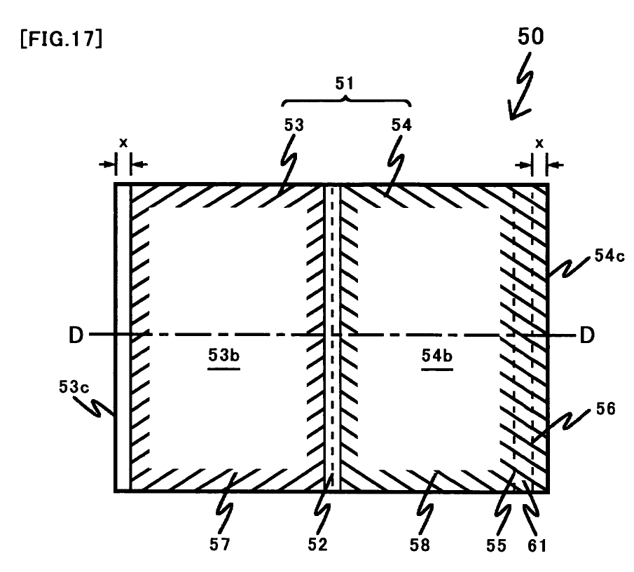

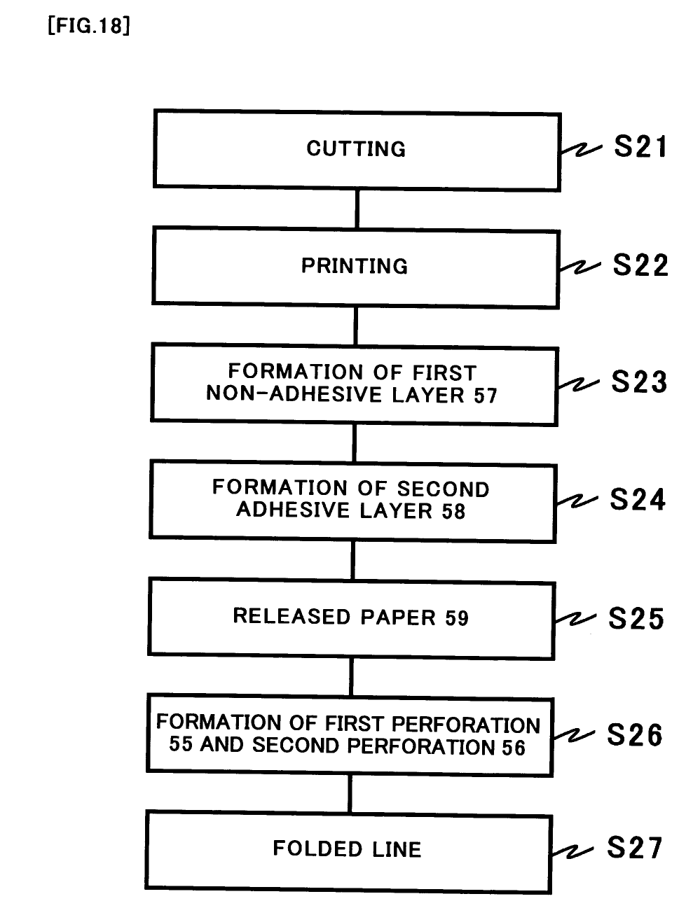

1. A secret postcard comprising a single sheet, and a released paper,
wherein said sheet is foldable about a return line, and has a first area and a second area, said return line being a boundary line between said first and second areas,
a first perforation extending in parallel with said return line, and a second perforation spaced away from said first perforation in a direction remote from said return line, and extending in parallel with said first perforation are formed in said second area,
a first adhesive layer is formed at a rear surface of said second area in an area sandwiched between said return line and said first perforation,
a second adhesive layer is formed at said rear surface of said second area in an area sandwiched between said second perforation and an edge of said second area extending in parallel with said return line,
said released paper is adhered onto said rear surface of said second area,
said first adhesive layer has such an adhesive force that said rear surface of said second area and a rear surface of said first area can be released from each other even after they were adhered to each other, and said rear surfaces of said first and second areas can be adhered again to each other, and
said second adhesive layer has such an adhesive force that said rear surfaces of said first and second areas cannot be released from each other after they were adhered to each other.

2. The secret postcard as set forth in claim 1, wherein said first adhesive layer is formed at said rear surface of said second area in an almost entire area.

3. A secret postcard comprising a single sheet, and a released paper,
wherein said sheet is foldable about a return line, and has a first area and a second area, said return line being a boundary line between said first and second areas,
a first perforation extending in parallel with said return line, and a second perforation spaced away from said first perforation in a direction remote from said return line, and extending in parallel with said first perforation are formed in said second area,
a first non-adhesive layer is formed at a rear surface of said first area,
a second adhesive layer is formed at a rear surface of said second area,
said first non-adhesive layer is formed so as not to overlap an area sandwiched between said second perforation and an edge of said second area extending in parallel with said return line when said rear surface of said first area is aligned with said rear surface of said second area about said return line,
said released paper is adhered onto said rear surface of said second area,
said first non-adhesive layer can be released from said second adhesive layer even after said rear surfaces of said first and second areas were adhered to each other, and
said second adhesive layer has such an adhesive force that said rear surfaces of said first and second areas cannot be released from each other after they were adhered to each other.

4. The secret postcard as set forth in claim 1, wherein said return line is comprised of a folded line.

5. The secret postcard as set forth in claim 1, wherein said return line is comprised of a perforation.

6. The secret postcard as set forth in claim 1, wherein said return line defines a central line of said sheet.

7. A secret postcard comprising a single sheet, and a released paper,
wherein said sheet is foldable about each of a first return line and a second return line, and defines a first area and a second area at opposite sides of said first return line, and a third area and said second area at opposite sides of said second return line,
a first perforation extending in parallel with said second return line, and a second perforation spaced away from said first perforation in a direction remote from said second return line, and extending in parallel with said first perforation are formed in said third area,
a first adhesive layer is formed at a rear surface of said second area,
a second adhesive layer is formed at a rear surface of said third area in an area sandwiched between said second perforation and an edge of said third area extending in parallel with said second perforation,
said released paper is adhered onto said rear surfaces of said second and third areas,
said first adhesive layer has such an adhesive force that said rear surfaces of said first and second areas can be released from each other even after they were adhered to each other, and said rear surfaces of said first and second areas can be adhered again to each other, and
said second adhesive layer has such an adhesive force that said rear surface of said third area and a front surface of said first area cannot be released from each other after they were adhered to each other.

8. The secret postcard as set forth in claim 7, wherein said first adhesive layer is formed at said rear surface of said second area in an almost entire area.

9. The secret postcard as set forth in claim 7, wherein each of said first and second return lines is comprised of one of a folded line and a perforation.

10. The secret postcard as set forth in claim 1, wherein an area sandwiched between said first and second perforations has different color or pattern from other areas.

11. A method of fabricating a secret postcard defined in claim 1, comprising:
cutting a postcard out of a paper;
simultaneously forming said first and second adhesive layers at said rear surface of said second area;
adhering said released paper to said rear surface of said second area; and
simultaneously forming said first and second perforations in said second area.

12. A method of fabricating a secret postcard defined in claim 3, comprising:
cutting a postcard out of a paper;
forming said first non-adhesive layer at said rear surface of said first area;
forming said second adhesive layer at said rear surface of said second area;
adhering said released paper to said rear surface of said second area; and
simultaneously forming said first and second perforations in said second area.

13. The method as set forth in claim 11, further comprising printing a pattern onto at least one of said first and second areas.

14. The method as set forth in claim 11, further comprising forming one of a folded line and a perforation as said return line.

15. A method of fabricating a secret postcard defined in claim 7, comprising:
cutting a postcard out of a paper;
simultaneously forming said first adhesive layer at said rear surface of said second area and said second adhesive layer at said rear surface of said third area;
adhering said released paper to said rear surface of said second area; and
simultaneously forming said first and second perforations in said third area.

16. The method as set forth in claim 15, further comprising printing a pattern onto at least one of said first, second and third areas.

17. The method as set forth in claim 15, further comprising forming one of a folded line and a perforation as said first and second return lines.

18. The secret postcard as set forth in claim 3, wherein said return line is comprised of a folded line.

19. The secret postcard as set forth in claim 3, wherein said return line is comprised of a perforation.

20. The secret postcard as set forth in claim 3, wherein said return line defines a central line of said sheet.

21. The secret postcard as set forth in claim 3, wherein an area sandwiched between said first and second perforations has different color or pattern from other areas.

22. The secret postcard as set forth in claim 7, wherein an area sandwiched between said first and second perforations has different color or pattern from other areas.
